(19) United States
(12) Patent Application Publication
(10) Pub. No.: US 2008/0237240 A1
(43) Pub. Date: Oct. 2, 2008

(54) Modular Container for Cryogenic Liquids

(75) Inventor: Klaus Hausberger, Graz (AT)

Correspondence Address: BACHMAN & LAPOINTE, P.C., 900 CHAPEL STREET, SUITE 1201, NEW HAVEN, CT, 06510, US

(73) Assignee: MAGNA STEYR FAHRZEUGTECHNIK AG & CO KG, Graz (AT)

(21) Appl. No.: 11/911,539

(22) PCT Filed: Apr. 13, 2006
(86) PCT No.: PCT/AT06/00150

§ 371 Date: May 10, 2008

(30) Foreign Application Priority Data
Apr. 13, 2005 (AT) GM 228/2005

(51) Int. Cl. F17C 1/12

(52) U.S. Cl. 220/560.07; 220/560.12

(57) ABSTRACT

A container for cryogenic fuels assembled from a plurality of identical straight and closed profiles which are arranged in different configuration from one another and are straight hollow profiles which are arranged parallel to one another and of which at least one outer boundary wall maintains a functional distance from an outer boundary wall of an adjacent profile and to the open ends of which a common cap as a common connection space of the profiles is in each case contiguous on both sides.

### BACKGROUND OF THE INVENTION

The invention relates to a container for cryogenic fuels of a flattened type of construction which is surrounded by insulation. In containers for cryogenic fuel, a flattened type of construction is desirable, above all, when they are intended for use in motor vehicles. The hitherto conventional barrel-shaped containers with the superinsulation surrounding them are extremely unfavorable because of their poor space utilization, and they take up the entire trunk space of a motor vehicle.

Such a container is known from EP 1 067 300 A1. It consists of an upper and of a lower shell consisting of a plastic, which are connected to one another at a plurality of locations by means of tubular tension struts, in order to prevent the shells from bulging out due to the internal pressure. Although, as a result of this, the container can be given a favorable shape for installation in a specific motor vehicle, this shape nevertheless has to be redeveloped and redesigned for each model, new shapes and dies then having to be obtained each time. In the case of containers which are not cylindrical, a special problem is presented by the heat stresses which occur, for example, when the container is being filled (temperature differences of up to 333 degrees Celsius arise in the case of liquid hydrogen).

The object of the invention, therefore, is to propose for such containers a type of construction which allows automatable manufacture and also a modular structural adaption to various vehicle models and packaging stipulations, along with substantially lower costs, the weight-optimized and shape-optimized design not being damaged by thermal and mechanical stresses.

### SUMMARY OF THE INVENTION

According to the invention, the container is assembled from a plurality of identical straight closed profiles which are connectable to one another in various configurations and are arranged parallel to one another and of which at least one outer boundary wall is arranged at a short distance from and parallel to a boundary wall of an adjacent profile and to the open ends of which a common cap is in each case contiguous on both sides. By the elements being identical, not only can different shapes be implemented, but the design is also simpler, because the stresses and deformations of the individual elements are identical. Since the outer walls of the profiles are parallel, the densest possible packaging is achieved. The caps make the connection between the contents of the individual profiles arranged next to one another.

The short distance between the parallel outer walls of the profiles allows the process-safe cleaning of the outer surfaces of the inner tank and the generation of the high vacuum required for heat insulation between the inner tank container and the outer container surrounding it. Since the profiles communicate with one another at their ends via the caps, their connection and sealing are so simple that containers according to the invention can be produced in an automated manner. The pipe connections for supply and outward discharge are integrated into the caps, so that the elements consist only of standard profiles which are cut off to the correct length and require no complicated machining. As a result of this, too, the production costs can be lowered considerably.

The outer boundary walls of the profiles form, in cross section, essentially a rectangle, in particular an equilateral rectangle—a square. Thus, they can be arranged next to one another and one above the other with the highest possible packing density and, moreover, can be produced, process-safe, by the extrusion method. Further, what are thus achieved are an optimal thermal behavior and a planar support for the reflection foils which are provided for forming a superinsulation in the vacuum space between the container and its outer container. The outer profiles must have large roundings, because the caps cannot otherwise be produced.

The short distance between the parallel outer walls of the profiles for the process-safe generation of the vacuum is 1 to 8, preferably 3 to 5 millimeters. This counteracts the traction by capillary forces during the cleaning process.

Preferably, the profiles have inside, over their entire length, reinforcements with generatrices lying in the longitudinal direction. These inner profilings therefore connect the outer walls of the profiles over the entire length and counteract the internal pressure. In a preferred embodiment, in the case of a rectangular or square cross section of the profile, the reinforcements are, in cross section, symmetricals which form sides in the manner of a window cross.

In another embodiment, the reinforcements are curved in an arc-like manner in cross section and impinge at an acute or obtuse angle onto the inside of the outer walls. Owing to the curvature and the acute angles, temperature differences can be absorbed by means of suitable deformation, without thermal stresses leading to plastic deformations or cracks.

The reinforcements may have various shapes in cross section, depending on requirements, the size of the cross section, material and wall thickness. They may be designed to be oval, in particular in the form of an arc of a circle, so that the thermal stresses are absorbed by the profile parts which are in the form of an arc of a circle. In a further variant, the reinforcements designed to be oval or circular in cross section can be tangent to the outer walls.

Moreover, for profiles placed so as to close off at the edges, it is beneficial if at least two of the outer boundary walls, forming essentially a square, of the profiles merge with a rounding one into the other. The rounded edges assist in the bearing contact of the superinsulation foils (MLI) in the high vacuum space, which, thanks to them, are not subjected to any sharp bend.

Since the profiles are straight and have a cross section constant over their entire length, they are advantageously either extruded profiles consisting of a suitable light metal alloy, preferably of an aluminum alloy, or rolled profiles consisting of austenitic steel.

### BRIEF DESCRIPTION OF THE DRAWINGS

The invention is described and explained below with reference to figures in which:

FIG. 1 illustrates a top view of a container according to the invention,

FIG. 2 illustrates a section AA in FIG. 1,

FIG. 3 illustrates a section BB in FIG. 2,

FIG. 4 illustrates a first variant of the profile,

FIG. 5 shows a special form of FIG. 4,

FIG. 6 shows a second variant of the profile,

FIG. 7 shows a third variant of the profile.

### DETAILED DESCRIPTION

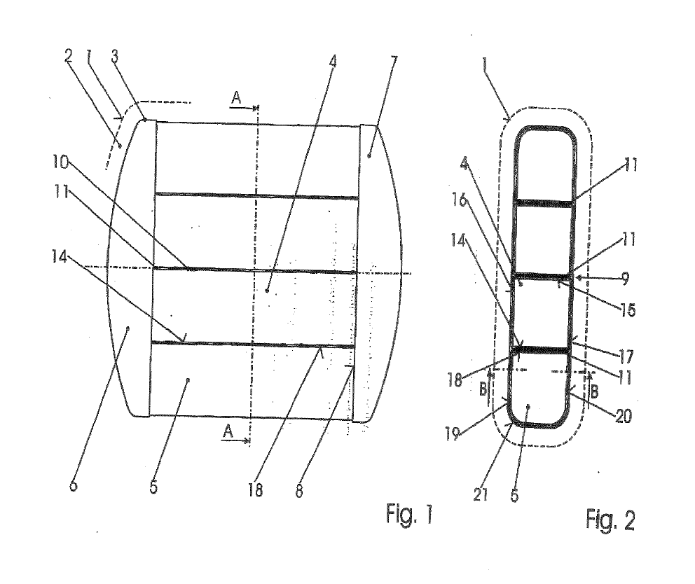

In FIG. 1, the container according to the invention is designated by 3. An outer container 1 surrounding it is indicated merely by dashes, and the vacuum zone surrounding the container 3 and having superinsulation is designated by 2. The container 3 consists here of four elements, of which a middle one is designated by 4 and one forming the edge is designated by 5, and of two caps 6, 7. The elements 4, 5 are straight closed profiles with a cross section constant over their length. A common cap 6, 7 combining all the elements and connecting their contents is contiguous to their ends in each case on both sides. The connecting line between the cap and the profiles forming the elements is designated by 8, the elements being sealingly welded to the cap along this line. Between the planar boundary surface 9, 9′ of adjacent profiles, there is a short distance 10 which is bridged by an insert plate 11 for connection to the caps.

The elements 4, 5 bearing against one another in parallel and at a short distance 10 can be seen in cross section in FIG. 2. The outer boundary walls of the profile 4 are designated by 14, 15, 16, 17, and they are of equal length and form right angles, therefore forming a square here. The element 5 is a special form of the element 4. It differs from the latter only in the rounding 21, because it is an outer element. The elements 4, 5 are arranged with their outer boundary walls 14, 18 at a short distance 11 from one another. However, a further element having the configuration of the element 4 could also be contiguous to one of the side faces 17 of the element 4.

Overall, therefore, very different overall cross sections of the container can be produced by means of a corresponding arrangement of elements next to one another or one above the other. The elements may be without inner reinforcements if the profiles have sufficient strength.

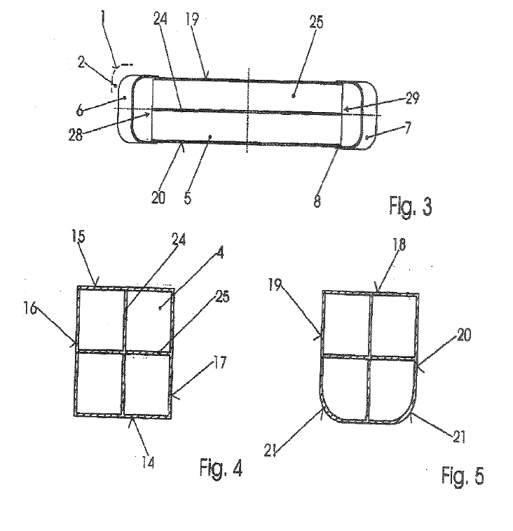

It can seen in FIG. 3 that the elements 4, 5 are open at their ends 28, 29 on both sides and all issue into the space formed by the caps 6, 7. The caps are the closing-off connection space between the individual parallel profiles. Both supports and pipe connections, not illustrated, and elements for the container suspension may be integrated into the caps 6, 7.

A profile with reinforcements 24, 25 can be seen in FIG. 4. These are here symmetricals of the square sides, and they connect their centers and form a right-angled cross (see also FIG. 3). FIG. 5 differs from FIG. 4 only in the roundings 21. The walls 19, 20 merge one into the other via a rounding 21.

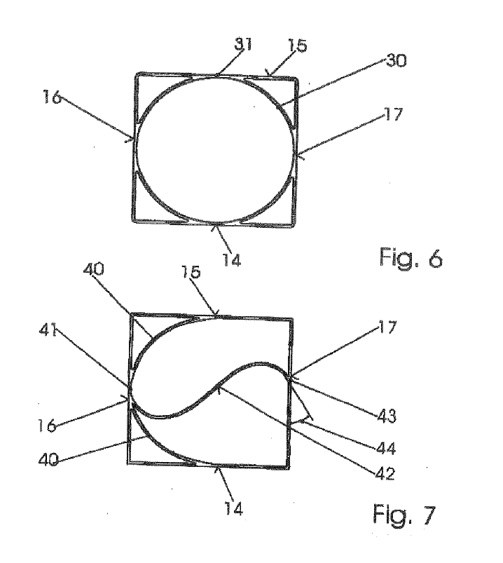

In the variant of FIG. 6, the outer boundary walls are again designated by 14 to 17. The reinforcement consists here of a pipe, in section a circle 30, which is the circle inscribed in the square formed by the outer boundary walls. It is tangent to the outer boundary walls at points 31.

In the variant of FIG. 7, the reinforcement is formed by two quarter circle arcs 40 and an S-shaped web 42 curved in an arc-like manner. Both touch the outer wall 16 at a point 14, the part curved in an arc-like manner touching the outer wall 17 at a point 43 at an acute (or obtuse complementary) angle 44.

The elements described may be extruded closed metal profiles (consisting of light metal or roll-formed profiles consisting of an austenitic steel). Overall, therefore, a modular, lightweight, rigid and cost-effective container is provided, which satisfies all requirements.

1-11. (canceled)

12. A container for cryogenic fuels of a flattened type of construction which is surrounded by insulation, comprising a plurality of identical hollow straight closed profiles which are connectable to one another and are arranged parallel to one another, wherein at least one outer boundary wall of one profile is arranged at a distance from and parallel to an outer boundary wall of an adjacent profile, and wherein hollow ends of the adjacent profiles are closed off by a cap member.

13. The container as claimed in claim 12, wherein the outer boundary walls of the profiles form in cross section a rectangle.

14. The container as claimed in claim 12, wherein the outer boundary walls of the profiles form in cross section a square.

15. The container as claimed in claim 12, wherein the distance between the parallel outer boundary walls lies in the region of between 1 millimeter and 8 millimeters.

16. The container as claimed in claim 12, wherein the distance between the parallel outer boundary walls lies in the region of between 3 and 5 millimeters.

17. The container as claimed in claim 12, wherein the profiles have inside, over their entire length, reinforcements with generatrices lying in the longitudinal direction.

18. The container as claimed in claim 17, wherein the reinforcements form, in cross section, symmetricals of the sides.

19. The container as claimed in claim 17, wherein the reinforcements are curved in an arc-like manner in cross section and impinge at an angle onto the outer walls.

20. The container as claimed in claim 17, wherein the reinforcements are oval, in the form of an arc of a circle (30), in cross sections.

21. The container as claimed in claim 20, wherein the reinforcements are tangent to outer walls of the profiles.

22. The container as claimed in claim 12, wherein at least two of the outer boundary walls, forming a square, of the profiles merge with a rounding one into the other.

23. The container as claimed in claim 12, wherein the profile is a closed extruded profile consisting of a light metal.

24. The container as claimed in claim 12, wherein the profile is a rolled closed profile consisting of austenitic steel.
